(19) United States
(12) Patent Application Publication
(10) Pub. No.: US 2015/0377445 A1
(43) Pub. Date: Dec. 31, 2015

(54) VEHICLE LIGHTING DEVICE

(71) Applicants: Fu-Ming Chuang, Hsin-Chu (TW); Chien-Chung Liao, Hsin-Chu (TW)

(72) Inventors: Fu-Ming Chuang, Hsin-Chu (TW); Chien-Chung Liao, Hsin-Chu (TW)

(73) Assignee: Coretronic Corporation, Hsin-Chu (TW)

(21) Appl. No.: 14/495,914

(22) Filed: Sep. 25, 2014

(30) Foreign Application Priority Data
Jun. 26, 2014 (CN) 201410295591.X

(51) Int. Cl. F21S 8/10; B60Q 1/08

(52) U.S. Cl. CPC F21S 48/1757; F21S 48/125; B60Q 1/085

(57) ABSTRACT

A vehicle lighting device including a light source module, a light valve, a sensing unit, a projection lens set and a control unit. The light source module provides an illumination beam. The light valve is located on a transmission path of the illumination beam, and is capable of being switched to different states for adjusting the illumination beam. The sensing unit senses the front of the vehicle lighting device and generates a signal. The projection lens set is disposed on an optical path of the illumination beam for projecting at least a portion of the illumination beam. The control unit is electrically connected to the light valve and the sensing unit for receiving the signal. The control unit controls the light valve to adjust a light distribution pattern of the illumination beam according to the signal, and project the illumination beam to the front through the projection lens set.

### CROSS-REFERENCE TO RELATED APPLICATION

This application claims the priority benefit of Chinese application serial no. 201410295591.X, filed on Jun. 26, 2014. The entirety of the above-mentioned patent application is hereby incorporated by reference herein and made a part of this specification.

### BACKGROUND

1. Technical Field

The invention relates to a lighting device, and particularly relates to a vehicle lighting device.

2. Related Art

Recently, vehicle front lights composed of solid-state light sources such as light-emitting diodes (LEDs) and laser diodes gradually occupy a space in the market. A light-emitting efficiency of the LED is approximately between 5%-8%, and the LEDs have different color temperatures and an excellent power-saving effect. On the other hand, since the laser diode has a light-emitting efficiency of about 20% higher, in order to break through the limitation of the luminous efficiency of the LED, an applicable and high-efficiency light source produced by using the laser light source to excite fluorescent powder is gradually developed. Therefore, the solid-state light sources are now actively applied to light source modules of mainstream vehicle front lights of a new generation. Particularly, under a premise of safety, development of the solid-state light source in an adaptive front lighting system (AFS) draws more attention.

However, generally, the AFS adopts a plurality of light sources, and the light sources are required to be guided to different directions through a lens design or a physical angle configuration, and the light sources are switched to achieve an effect of modifying a light shape. Therefore, limited by the number of the light sources, quick and fine adjustment of the light shape cannot be achieved, or dynamic adjustment of the light shape based on a position of the vehicle coming in the opposite direction cannot be achieved.

U.S. Pat. No. 8,033,697 discloses a road adaptive vehicle front lighting system. China Patent Publication No. CN102939500A discloses a front light module for vehicle. Taiwan Patent Publication No. TW201202076 discloses a vehicle lighting system. China Patent No. CN203068374U discloses a vehicle headlight.

### SUMMARY

The invention is directed to a vehicle lighting device, which is capable of adjusting a light distribution pattern of a projected illumination beam.

Other objects and advantages of the invention can be further illustrated by the technical features broadly embodied and described as follows.

In order to achieve one or a portion of or all of the objects or other objects, an embodiment of the invention provides a vehicle lighting device including a light source module, a light valve, a sensing unit, a projection lens set and a control unit. The light source module provides an illumination beam. The light valve is located on a transmission path of the illumination beam, and the light valve is capable of being switched to different states for adjusting and controlling the illumination beam. The sensing unit is configured to sense the front of the vehicle lighting device and generates a signal, correspondingly. The projection lens set is disposed on an optical path of the illumination beam, and is configured to project at least a portion of the illumination beam, where the light valve is located between the light source module and the projection lens set. The control unit is electrically connected to the light valve and the sensing unit, and is configured to receive the signal output from the sensing unit, and the control unit controls the light valve to adjust a light distribution pattern of the illumination beam according to the signal, and to project the illumination beam to the front through the projection lens set.

In order to achieve one or a portion of or all of the objects or other objects, an embodiment of the invention provides a method for controlling a vehicle lighting device, which is capable of controlling a light distribution pattern of an illumination beam, and the method for controlling the vehicle lighting device includes following step. A sensing unit is caused to sense the front of the vehicle lighting device and to generate a signal. A light valve located on a transmission path of the illumination beam is controlled according to the signal, so as to adjust the light distribution pattern of at least a portion of the illumination beam.

In an embodiment of the invention, the projection lens set includes a zoom lens, which is electrically connected to the control unit, and is configured to control a projection distance of the illumination beam projected out of the projection lens set.

In an embodiment of the invention, the light valve includes a digital micro-mirror device, the digital micro-mirror device includes a plurality of micro-mirrors, and the control unit controls states of the micro-mirrors to reflect the portion of the illumination beam and adjust the light distribution pattern of the illumination beam.

In an embodiment of the invention, the light source module includes at least one first light source and at least one second light source for respectively providing a first sub illumination beam and a second sub illumination beam of the illumination beam, and a color temperature of the first sub illumination beam and a color temperature of the second sub illumination beam are different.

In an embodiment of the invention, the control unit controls light intensities of the first sub illumination beam and the second sub illumination beam of the light source module, so as to adjust a color temperature of the illumination beam.

In an embodiment of the invention, the light source module further includes at least one first light wavelength converting unit and at least one second light wavelength converting unit. The first light wavelength converting unit is located between the first light source and the light valve. The second light wavelength converting unit is located between the second light source and the light valve. The first light wavelength converting unit and the second light wavelength converting unit respectively correspond to the first light source and the second light source, and the first sub illumination beam and the second sub illumination beam are respectively converted by the first light wavelength converting unit and the second light wavelength converting unit.

In an embodiment of the invention, the first light source and the second light source are solid-state light sources.

In an embodiment of the invention, the micro-mirrors are capable of oscillating independently, and different states of the micro-mirrors correspond to different oscillating angles and control a reflecting direction that the illumination beam irradiates each of the micro-mirrors, so as to adjust the light distribution pattern of at least a portion of the illumination beam.

In an embodiment of the invention, the vehicle lighting device further includes a relay lens set, which is located on the transmission path of the illumination beam, and located between the light source module and the light valve, and the illumination beam is transmitted to the light valve through the relay lens set.

In an embodiment of the invention, the sensing unit is a complementary metal-oxide-semiconductor (CMOS) sensor, a time-of-flight (TOF) sensor or a humidity sensor.

In an embodiment of the invention, the signal includes image information, position information related to a vehicle coming from the opposite direction or humidity information.

In an embodiment of the invention, the control unit determines whether the vehicle coming from the opposite direction exists and a relative distance between the vehicle coming from the opposite direction and the sensing unit according to the signal having the image information or the position information related to the vehicle coming from the opposite direction, and the control unit controls the light valve to adjust the light distribution pattern of the illumination beam when determining that the vehicle coming from the opposite direction exists in the front.

In an embodiment of the invention, the control unit is electronically connected to the light source module, and when the humidity information reaches a predetermined value, the control unit controls the light source module to adjust the color temperature of the illumination beam.

In an embodiment of the invention, the illumination beam is provided by a light source module, and the light valve includes a digital micro-mirror device. The digital micro-mirror device includes a plurality of micro-mirrors, each of the micro-mirrors is capable of oscillating independently and is capable of being switched to different states, the different states of the micro-mirrors correspond to different oscillating angles, the states of the micro-mirrors are controlled to control a reflecting direction that the illumination beam irradiates each of the micro-mirrors, such that the digital micro-mirror device adjusts the light distribution pattern of at least a portion of the illumination beam through the micro-mirrors.

In an embodiment of the invention, the illumination beam includes a first sub illumination beam and a second sub illumination beam, a color temperature of the first sub illumination beam and a color temperature of the second sub illumination beam are different, and the method for controlling the vehicle lighting device further includes controlling light intensities of the first sub illumination beam and the second sub illumination beam, so as to adjust a color temperature of the illumination beam.

In an embodiment of the invention, the light source module further includes a plurality of first light sources and a plurality of second light sources, a plurality of first light wavelength converting units and a plurality of second light wavelength converting units. The first light sources and the second light sources are respectively configured to provide the first sub illumination beam and the second sub illumination beam. The first light wavelength converting units are located between the first light sources and the digital micro-mirror device. The second light wavelength converting units are located between the second light sources and the digital micro-mirror device, and the first light wavelength converting units and the second light wavelength converting units respectively correspond to the first light sources and the second light sources, and the first sub illumination beam and the second sub illumination beam are respectively converted by the first light wavelength converting units and the second light wavelength converting units.

In an embodiment of the invention, the method for controlling the vehicle lighting device further includes controlling the light source module to adjust the color temperature of the illumination beam when the humidity information reaches a predetermined value.

In an embodiment of the invention, the method for controlling the vehicle lighting device further includes determining whether a vehicle coming from the opposite direction exists and a relative distance between the vehicle coming from the opposite direction and the sensing unit according to the signal having the image information or the position information related to the vehicle coming from the opposite direction, and controlling the light valve to adjust the light distribution pattern of the illumination beam when determining that the vehicle coming from the opposite direction exists in the front.

According to the above descriptions, the embodiments of the invention have at least one of the following advantages or effects. In the vehicle lighting device and the method for controlling the vehicle lighting device of the invention, the light valve is used to adjust and control the illumination beam, so as to achieve a function of stepless adjustment of the light distribution pattern. Moreover, in the vehicle lighting device and the method for controlling the vehicle lighting device of the invention, the sensing unit is used to sense environmental requirement, and an illumination region and the light distribution pattern of the illumination beam is adjusted according to the signal of the sensing unit, so as to adapt to various driving conditions.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a structural schematic diagram of a vehicle lighting device according to an embodiment of the invention.

FIG. 1B is a schematic diagram of two micro-mirrors of a digital micro-mirror device of FIG. 1A in different states.

FIG. 1C is a flowchart illustrating a method for controlling a vehicle lighting device according to an embodiment of the invention.

FIG. 2, FIG. 3A, FIG. 3B, FIG. 4A and FIG. 4B are schematic diagrams of different illumination beams having different illumination regions and light distribution patterns that are projected by the vehicle lighting device of FIG. 1A.

FIG. 5 is a structural schematic diagram of a vehicle lighting device according to another embodiment of the invention.

FIG. 6A is a structural schematic diagram of a vehicle lighting device according to still another embodiment of the invention.

FIG. 6B is a spectral power-wavelength diagram of lights with different color temperatures of FIG. 6A.

FIG. 6C is a schematic diagram of a light source module of FIG. 6A.

FIG. 6D is a schematic diagram of another light source module of FIG. 6A.

### DETAILED DESCRIPTION OF DISCLOSED EMBODIMENTS

The present invention will now be described more fully with reference to the accompanying drawings, in which exemplary embodiments of the invention are shown. The terms used herein such as “above”, “below”, “front”, “back”, “left” and “right” are for the purpose of describing directions in the figures only and are not intended to be limiting of the invention.

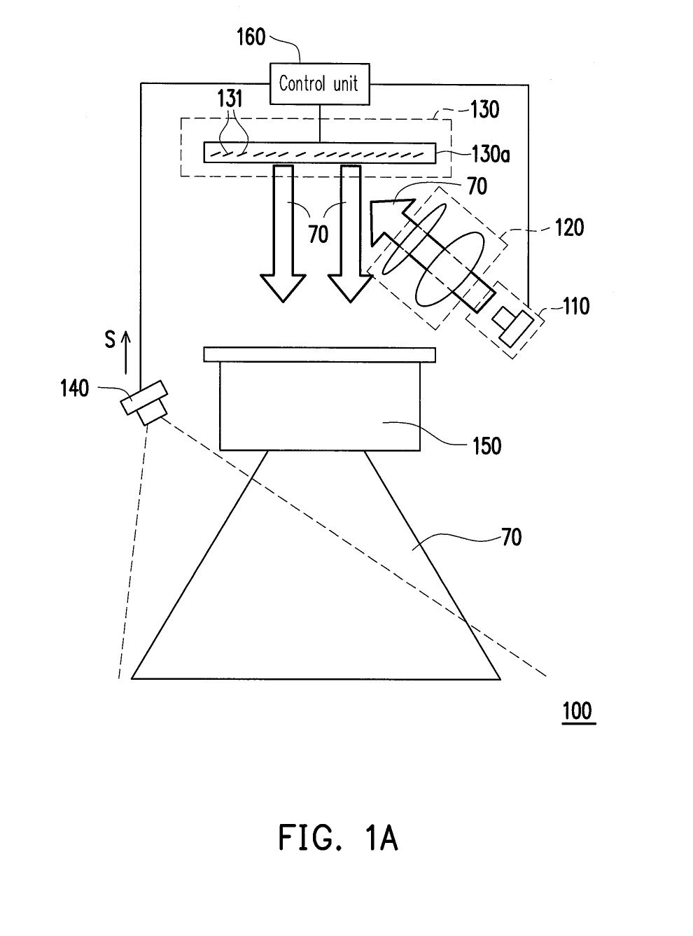

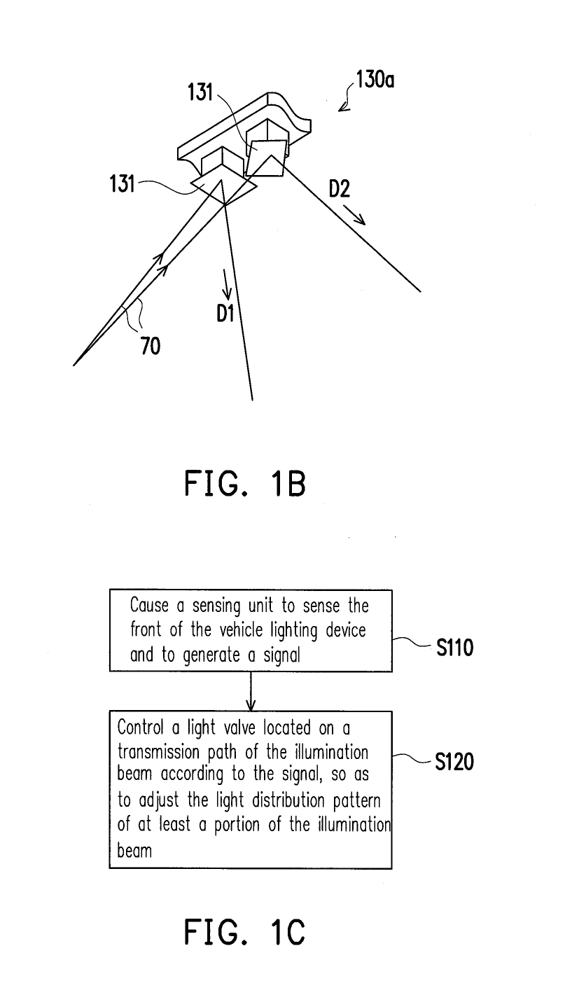

FIG. 1A is a structural schematic diagram of a vehicle lighting device according to an embodiment of the invention. FIG. 1B is a schematic diagram of two micro-mirrors of a digital micro-mirror device of FIG. 1A in different states. Referring to FIG. 1A, the vehicle lighting device 100 includes a light source module 110, a relay lens set 120, a light valve 130, a sensing unit 140, a projection lens set 150 and a control unit 160. The light valve 130 is defined as an optical element controlling a beam reflecting direction or an optical element that allows the beam to pass there through or blocks the beam, which is known by those skilled in the art. The light valve 130 can be a reflective light valve, for example, a digital micro-mirror device (DMD), a liquid crystal on silicon (LCOS) device, or a transmissive light valve, for example, a liquid crystal panel, etc., though the invention is not limited thereto. In the embodiment, the light valve 130 is, for example, a DMD 130a.

In detail, as shown in FIG. 1A, in the embodiment, the light source module 110 provides an illumination beam 70. In the embodiment, the light source 110 may include a white light-emitting diode (LED), and the illumination beam 70 is a white illumination beam, though the invention is not limited thereto. In other embodiments, the light source can also be a laser diode, a high-brightness LED, or other types of high-brightness light source, which is not limited by the invention. The relay lens set 120 and the light valve 130 are located on a transmission path of the illumination beam 70, and the relay lens set 120 is located between the light source module 110 and the light valve 130. When the light source module 110 emits the illumination beam 70, the illumination beam 70 is transmitted to the light valve 130 through the relay lens set 120. Moreover, the light valve 130 can be switched to different states for adjusting and controlling the illumination beam 70.

In detail, referring to FIG. 1A and FIG. 1B, in the embodiment, the light valve 130 is located between the light source module 110 and the projection lens set 150, and the light valve 130 includes the DMD 130a. As shown in FIG. 1B, the DMD 130a includes a plurality of micro-mirrors 131 formed in an array, where the DMD 130a controls the illumination beam 70 through the micro-mirrors 131 for adjusting the light distribution pattern and brightness of at least a portion of the illumination beam 70 incident to the projection lens set 150. For example, in the embodiment, each micro-mirror 131 is disposed on a micro-mirror unit (not numbered) and is operated by the micro-mirror unit. Each of the micro-mirrors 131 of the DMD 130a can be controlled to oscillate in small amplitude by a method based on a pulse width modulation (PWM), so as to adjust a ratio of light intensities of the beam projected to different directions.

Further, each of the micro-mirrors 131 may have different states. As shown in FIG. 1B, in the embodiment, each of the micro-mirrors 131 has an on-state and an off-state, and can be oscillated independently through the micro-mirror unit for switching between the on-state and the off-state. The different states of the micro-mirrors 131 correspond to different oscillating angles, and each state controls a reflecting direction of the illumination beam 70 irradiating each of the micro-mirrors 131, such that the micro-mirrors 131 are controlled to reflect at least a portion of the illumination beam 70 into the projection lens set 150.

For example, as shown in FIG. 1B, when the micro-mirror 131 is oscillated to a predetermined oscillating angle, the micro-mirror 131 is in the on-state. Now, if the illumination beam 70 is transmitted to the micro-mirror 131 in the on-state, the illumination beam 70 is reflected towards the projection lens set 150 along a direction D1. On the other hand, when the micro-mirror 131 is oscillated to another predetermined oscillating angle, the micro-mirror 131 is in the off-state. Now, if the illumination beam 70 is transmitted to the micromirror 131 in the off-state, the illumination beam 70 is reflected away from the projection lens set 150 along another direction D2, such that the illumination beam 70 is not projected to the front by the projection lens set 150. In this way, the light distribution pattern and the brightness of the illumination beam 70 incident to the projection lens set 150 can be varied along with the on-state or the off-state of each of the micro-mirrors 131. In other words, in the embodiment, the light distribution pattern and the brightness of the illumination beam 70 incident to the projection lens set 150 can be adjusted by independently controlling the on-state or the off-state of each of the micro-mirrors 131. The projection lens set 150 is located on the optical path of the illumination beam 70 reflected by the DMD 130a and is used for projecting at least a portion of the illumination beam 70.

On the other hand, referring o FIG. 1A again, in the embodiment, the sensing unit 140 is configured to sense the front environment of the vehicle lighting device 100, and generates a signal S according to a sensed environmental requirement. The control unit 160 is electrically connected to the light valve 130 and the sensing unit 140, and receives the signal S transmitted from the sensing unit 140. The control unit 160 controls the light valve 130 to adjust a light distribution pattern of the illumination beam 70 according to the signal S, and projects the adjusted illumination beam 70 to the front of the vehicle lighting device 100 through the projection lens set 150. Moreover, the control unit 160 can be a functional module implemented by hardware and/or software, where the hardware may include a hardware device having a data processing function such as a central processor, a chipset, a microprocessor, etc., or a combination thereof, and the software can be an operating system, a driving program, etc., though the invention is not limited thereto.

Functions of the sensing unit 140 and the control unit 160 of the vehicle lighting device 100 are further described below with reference of FIG. 1C to FIG. 3B.

FIG. 1C is a flowchart illustrating a method for controlling a vehicle lighting device according to an embodiment of the invention. Referring to FIG. 1A and FIG. 1C, in the embodiment, the method for controlling the vehicle lighting device can be executed by the vehicle lighting device 100 and the control unit 160 of FIG. 1A. Detailed steps of the method for controlling the vehicle lighting device are described below with reference of various components of the vehicle lighting device 100.

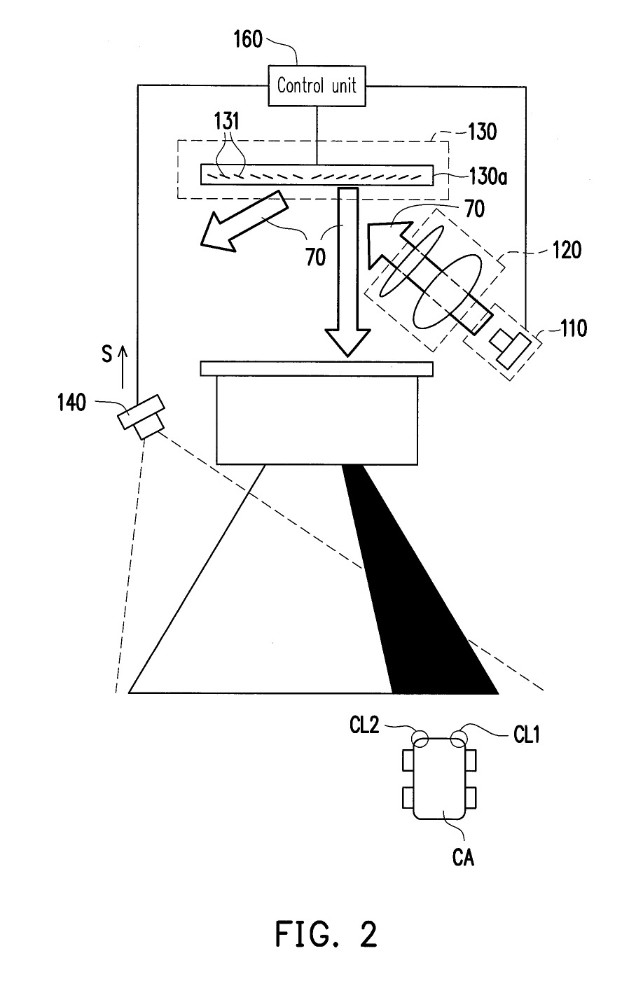

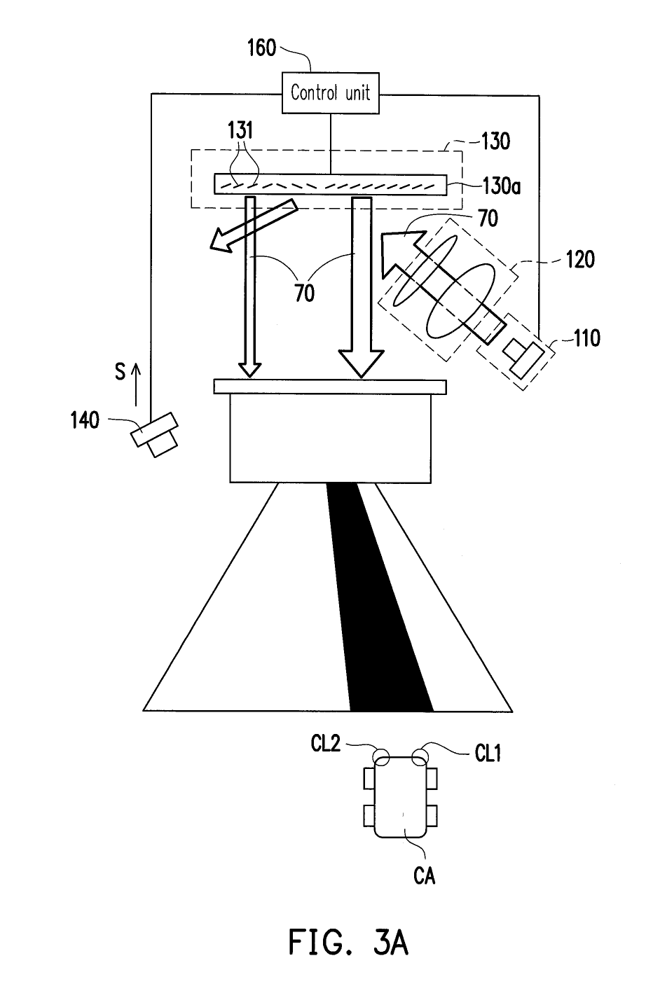

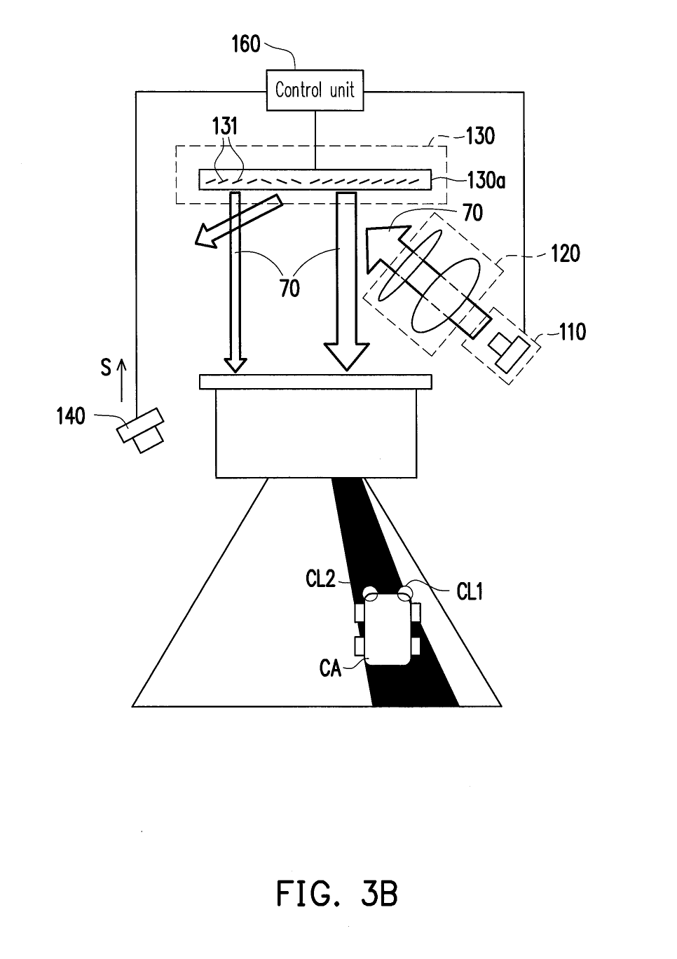

First, a step S110 is executed, by which the sensing unit 140 senses the front environment of the vehicle lighting device 100, and generate and transmit the signal S. In an embodiment, the sensing unit 140 is, for example, a complementary metal-oxide-semiconductor (CMOS) sensor and/or a time-of-flight (TOF) sensor, and the signal S includes image information, position information related to a vehicle CA (shown in FIG. 2) coming from the opposite direction, though the invention is not limited thereto. In other embodiments, the sensing unit 140 may also adopt a different type of sensor according to the environmental requirement to facilitate detecting various driving conditions.

Then, a step S120 is executed, by which the light valve 130 located on the transmission path of the illumination beam 70 is controlled according to the signal S to adjust the light distribution pattern of at least a portion of the illumination beam 70. For example, in the embodiment, the control unit 160 determines whether the vehicle CA coming from the opposite direction exists and a relative distance between the vehicle CA coming from the opposite direction and the sensing unit 140 according to the received signal S (i.e. the image information or the position information related to the vehicle CA coming from the opposite direction). In detail, in the embodiment, a method that the control unit 160 determines whether the vehicle CA coming from the opposite direction exists is, for example, to determine whether the vehicle CA coming from the opposite direction exists in the front according to image information transmitted by a CMOS sensor. The vehicle CA coming from the opposite direction is defined as the vehicle CA located in front of the vehicle lighting device 100 and driving towards the vehicle lighting device 100.

Situations that the vehicle lighting device 100 provides the required light according to various driving conditions are described below with reference of FIG. 2 to FIG. 4B.

FIG. 2, FIG. 3A, FIG. 3B, FIG. 4A and FIG. 4B are schematic diagrams different illumination beams projected by the vehicle lighting device of FIG. 1A. Referring to FIG. 1A first, in a general situation, when the sensing unit 140 senses the front environment of the vehicle lighting device 100 and transmits the signal S to the control unit 160, and the control unit 160 determines that no vehicle exists in the front, the micro-mirrors 131 of the DMD 130a are all in the on-state, and now the illumination beam 70 transmitted to the DMD 130a from the light source module 110 can be completely projected to the road ahead to obtain a lighting effect with better intensity of illumination.

On the other hand, when the control unit 160 determines that the vehicle CA coming from the opposite direction exists in the front, the control unit 160 controls the light valve 130 to adjust the light distribution pattern of the illumination beam 70, so as to adjust the light distribution pattern according to different vehicle speed, road environment and weather condition. For example, referring to FIG. 2, when the vehicle CA comes from the opposite direction on one side of the road, the control unit 160 can control the states of the micro-mirrors 131 of the DMD 130a to control the reflecting direction of the illumination beam 70 irradiating each of the micro-mirrors 131, such that the DMD 130a adjusts the light distribution pattern of at least a portion of the illumination beam 70 through operating the micro-mirrors 131 in different states. In detail, the micro-mirrors 131 of the DMD 130a that reflect beam to an region without the vehicle CA are switched to the on-state, and the micro-mirrors 131 of the DMD 130a that reflect beam to an region having the vehicle CA are switched to the off-state, and now only a portion of the illumination beam 70 transmitted to the DMD 130a is reflected by the micro-mirrors 131 in the on-state and is transmitted to the projection lens set 150. In this way, the light distribution pattern of the portion of the illumination beam 70 projected by the projection lens set 150 is formed on one side without the vehicle CA. The invention is not limited to the aforementioned adjustment of the light distribution pattern. And the micro-mirrors 131 that may reflect beam to a driver's seat of the vehicle CA coming from the opposite direction are switched to the off-state, such that the light distribution pattern of the portion of the illumination beam 70 projected by the projection lens set 150 can be arranged to prevent from glaring the driver of the vehicle CA coming from the opposite direction.

Further, the control unit 160 can also calculate a relative position of the vehicle CA coming from the opposite direction according to the signal S including image information. For example, referring to FIG. 3A and FIG. 3B, the control unit 160 can calculate a relative distance between the vehicle lighting device 100 and the vehicle CA coming from the opposite direction based on variation of a relative position between two headlights CL1 and CL2 of the vehicle CA coming from the opposite direction according to the image information of the signal S detected by the sensing unit 140 at different time points. Moreover, the sensing unit 140 may also adopt a TOF sensor, and the control unit 160 determines a distance between the vehicle CA coming from the opposite direction and the vehicle lighting device 100 (shown in FIG. 1A). Alternatively, the sensing unit 140 of the vehicle lighting device 100 (shown in FIG. 1A) can also simultaneously adopt the aforementioned CMOS sensor and the TOF sensor to accurately obtain the distance between the vehicle CA coming from the opposite direction and the vehicle lighting device 100 (shown in FIG. 1A), and the light distribution pattern of the illumination beam 70 projected by the projection lens set 150 can be dynamically adjusted by correspondingly controlling the DMD 130a.

In this way, while an adequate lighting effect is maintained, the driver in the vehicle CA coming from the opposite direction is avoided to feel a glare. Moreover, the vehicle lighting device 100 (shown in FIG. 1A) can automatically adjust a projection distance of the illumination beam 70 projected out of the projection lens set 150 and an illumination region of the required light distribution pattern to obtain light distribution patterns and illumination ranges required by a high beam and a low beam, so as to satisfy various driving conditions. Moreover, the vehicle lighting device 100 is at least complied with a UN economic commission of Europe (ECE) regulation issued by ECE, which specifies that the low beam of the vehicle lighting device 100 has to be complied with a standard that the main light pattern is distributed below a horizontal cut-off line.

Moreover, in the embodiment, the projection lens set 150 further includes a zoom lens 151, which is electrically connected to the control unit 160 for controlling a projection distance of the illumination beam 70 projected out of the projection lens set 150. For example, referring to FIG. 4A and FIG. 4B, the projection lens set 150 can adjust the projection distance of the illumination beam 70 and an illumination range covered by the required light distribution pattern by operating the zoom lens 151 to adjust an angle of the illumination beam 70 projected out of the projection lens set 150, so as to obtain the light distribution patterns and brightness required by the high beam and the low beam, and avoid loss of optical energy to meet various driving conditions.

Since the vehicle lighting device 100 and the method for controlling the vehicle lighting device can adjust and control the illumination beam 70 through the light valve 130, a function of a stepless adjustment of the light distribution pattern is achieved. Moreover, the vehicle lighting device 100 and the method for controlling the vehicle lighting device can use the sensing unit 140 to sense the environmental requirement in the front of the vehicle lighting device 100, and can adjust the illumination region of the required light distribution pattern according to the signal S of the sensing unit 140 to obtain the light distribution pattern, the brightness and the illumination range required by the high beam, the low beam and the adaptive front lighting system, so as to satisfy various driving conditions and cope with related specification standards.

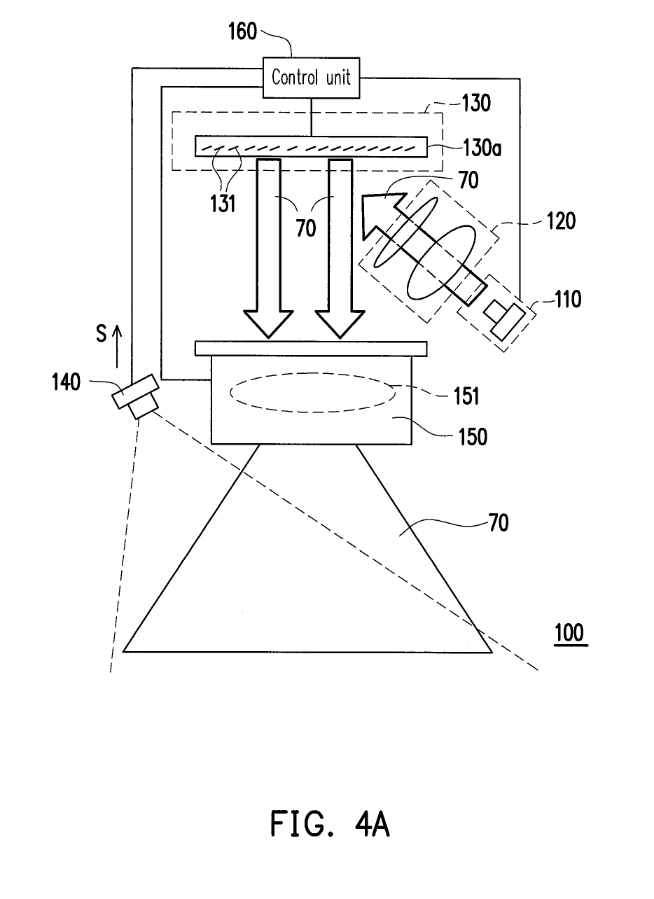

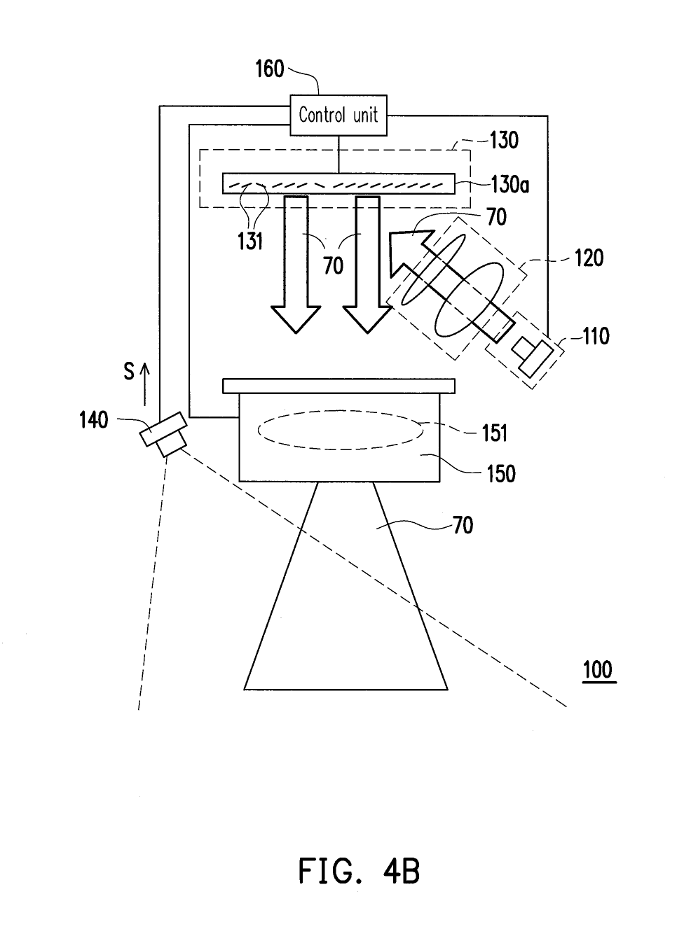

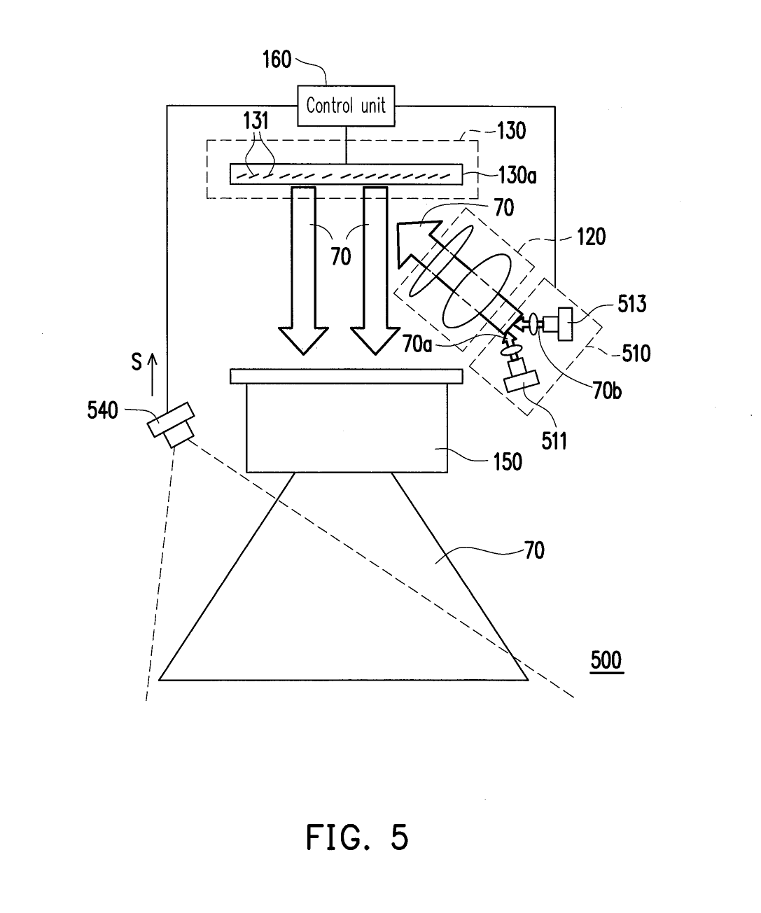

FIG. 5 is a structural schematic diagram of a vehicle lighting device according to another embodiment of the invention. In the embodiment, the vehicle lighting device 500 of FIG. 5 is similar to the vehicle lighting device 100 of FIG. 1, and differences therebetween are as follows. As shown in FIG. 5, in the embodiment, the light source module 510 includes at least one first light source 511 and at least one second light source 513, which are respectively used for providing a first sub illumination beam 70a and a second sub illumination beam 70b. The first sub illumination beam 70a and the second sub illumination beam 70b are combined to form the illumination beam 70 through the relay lens set 120. A color temperature of the first sub illumination beam 70a and a color temperature of the second sub illumination beam 70b are different. In detail, in the embodiment, the first light source 511 and the second light source 513 can be solid-state light sources, for example, light-emitting diodes (LEDs) or laser diodes, though the invention is not limited thereto. For example, the first light source 511 and the second light source 513 are LEDs having different color temperatures or an LED array, where the color temperature of the first light source 511 is, for example, 3000K (Kelvin), and the color temperature of the second light source 513 is, for example 5000K. It should be noticed that the above values are only used as an example, and are not used for limiting the invention.

Further, in the embodiment, the control unit 160 of the vehicle lighting device 500 is electrically connected to the light source module 510. In this way, the control unit 160 respectively controls a light intensity of the first sub illumination beam 70a emitted from the first light source 511 and a light intensity of the second sub illumination beam 70b emitted from the second light source 513 to adjust the color temperature of the illumination beam 70, so as to adapt to a weather condition, an environmental condition or user's preference. In other words, when the vehicle lighting device 500 executes the method for controlling the vehicle lighting device shown in FIG. 1C, the sensing unit 540 and the control unit 160 of the vehicle lighting device 500 can be used the adjust a ratio of the color temperature of the first sub illumination beam 70a and the color temperature of the second sub illumination beam 70b according to an actual requirement, so as to adjust the color temperature of the illumination beam 70 projected out of the vehicle lighting device 500.

For example, in the embodiment, the sensing unit 540 may include a humidity sensor, and the signal S transmitted by the sensing unit 540 includes humidity information related to the front environment of the vehicle lighting device 500. When the humidity information reaches a predetermined value, the control unit 160 can control the light source module 510 to adjust the color temperature of the illumination beam 70 to adapt to the weather requirement. In detail, the predetermined value can be obtained by simulating driving condition of a rainy day or a foggy day, and now the control unit 160 can adjust and control the light intensity of the first light source 511 to be relatively higher than the light intensity of the second light source 513 to obtain the illumination beam 70 having a lower color temperature through mixing, such that the vehicle lighting device 500 is adapted to the driving condition of the rainy day or the foggy day.

Moreover, in the embodiment, the sensing unit 540 of the vehicle lighting device 500 can also simultaneously adopts the aforementioned CMOS sensor and the TOF sensor to accurately obtain the relative distance between the vehicle CA coming from the opposite direction and the vehicle lighting device 500, and the control unit 160 can dynamically adjust the light distribution pattern of the illumination beam 70. In this way, while an adequate lighting effect is maintained, the driver in the vehicle CA coming from the opposite direction is avoided to feel a glare.

Therefore, the vehicle lighting device 500 and the method for controlling the vehicle lighting device can use the light valve 130 to adjust and control the illumination beam 70 to implement the function of stepless adjustment of light distribution pattern, and the sensing unit 540 can be used to sense the environmental requirement, so as to adjust the light distribution pattern, the brightness and the illumination range of the illumination beam 70 to satisfy various driving conditions and cope with related specification standards. Therefore, the vehicle lighting device 500 also have the advantages mentioned in description of the vehicle lighting device 100, which are not repeated.

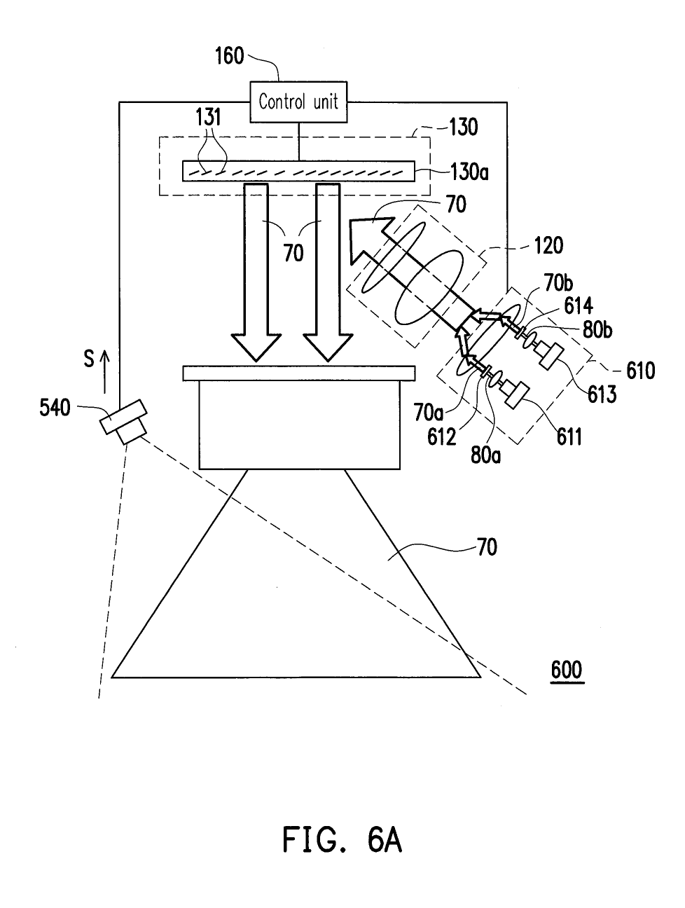

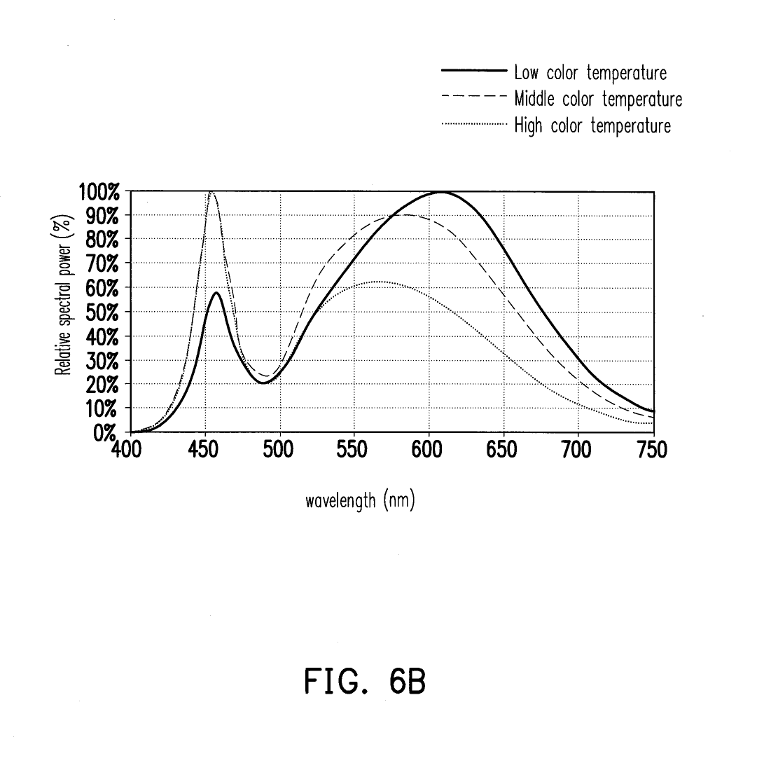

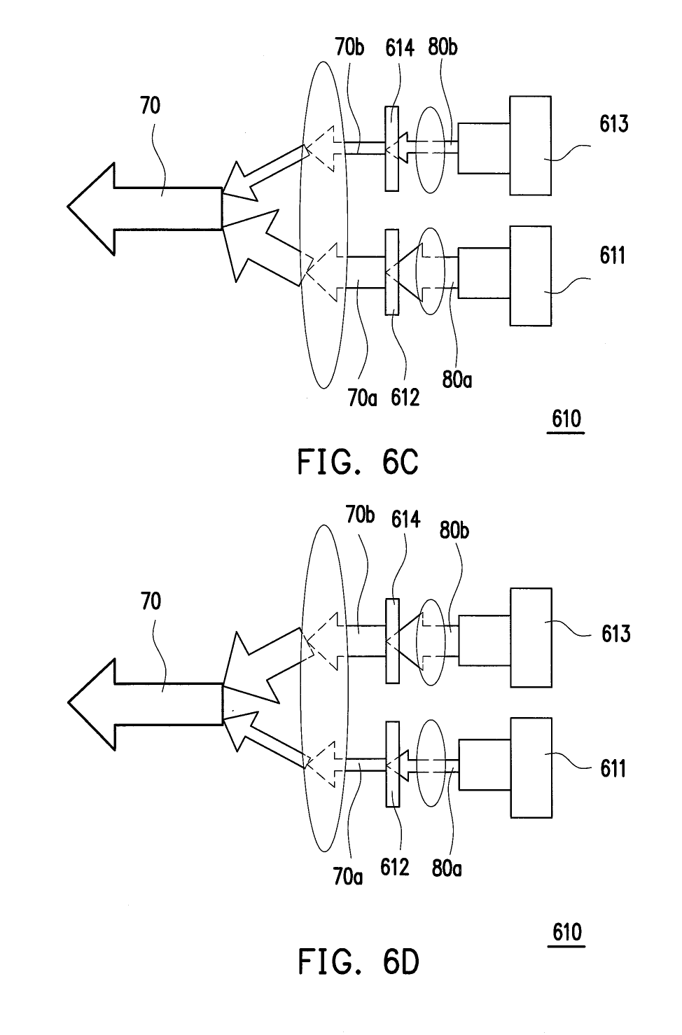

It should be noticed that although the first light source 511 and the second light source 513 implemented by the LEDs having different color temperatures are taken as an example for description, the invention is not limited thereto. In other embodiments, the first light source and the second light source can also be implemented by laser diodes or a laser diode array, and a corresponding light wavelength converting unit can be used in collaboration to generate the first sub illumination beam 70a and the second sub illumination beam 70b having different color temperatures. Further descriptions is made below with reference of FIG. 6A to FIG. 6D.

FIG. 6A is a structural schematic diagram of a vehicle lighting device according to still another embodiment of the invention. FIG. 6B is a spectral power-wavelength diagram of lights with different color temperatures of FIG. 6A. FIG. 6C is a schematic diagram of a light source module of FIG. 6A. FIG. 6D is a schematic diagram of another light source module of FIG. 6A. In the embodiment, the vehicle lighting device 600 of FIG. 6A is similar to the vehicle lighting device 500 of FIG. 5, and differences therebetween are as follows. As shown in FIG. 6A, in the embodiment, the light source module 610 includes at least one first light source 611 and at least one second light source 613, where the first light source 611 and the second light source 613 can be blue light laser diodes respectively used for providing blue illumination beams 80a and 80b, and the light source module 610 further includes at least one first light wavelength converting unit 612 and at least one second light wavelength converging unit 614. The first light wavelength converting unit 612 is located between the first light source 611 and the DMD 130a. The second light wavelength converging unit 614 is located between the second light source 613 and the DMD 130a, and the first light wavelength converting unit 612 and the second light wavelength converging unit 614 respectively correspond to the first light source 611 and the second light source 613.

In detail, the first light wavelength converting unit 612 and the second light wavelength converging unit 614 can be a plurality of fluorescent powders, for example, a mixture of a yellow light fluorescent powder and a red light fluorescent powder, and mixing ratios of the yellow light fluorescent powders and the red light fluorescent powders in the first light wavelength converting unit 612 and the second light wavelength converging unit 614 are different. Therefore, the color temperatures of the first sub illumination beam 70a and the second sub illumination beam 70b can be adjusted by controlling a mixing ratio of various fluorescent powders in the first light wavelength converting unit 612 and the second light wavelength converging unit 614 and light intensities of the blue light beams 80a and 80b.

For example, referring to FIG. 6A and FIG. 6B, when the first light source 611 and the second light source 613 respectively provide the blue illumination beams 80a and 80b, the blue illumination beams 80a and 80b are respectively transmitted to the corresponding first light wavelength converting unit 612 and the second light wavelength converging unit 614 and are respectively converted into the first sub illumination beam 70 and the second sub illumination beam 70b. Moreover, the first light wavelength converting unit 612 may contain a higher ratio of the red light fluorescent powder, such that the blue illumination beam 80a is converted into the first sub illumination beam 70a with a low color temperature (shown in FIG. 6B). On the other hand, the second light wavelength converting unit 614 may contain a higher ratio of the yellow light fluorescent powder, such that the blue light beam 80b is converted into the second sub illumination beam 70b with a middle color temperature or a high color temperature (shown in FIG. 6B). In this way, since mixing ratios of the fluorescent powders of the first light wavelength converting unit 612 and the second light wavelength converging unit 614 are different, the color temperature of the first sub illumination beam 70a converted by the first light wavelength converting unit 612 and the color temperature of the second sub illumination beam 70b converted by the second light wavelength converting unit 614 are also different.

Further, the vehicle lighting device 600 can control the light intensities of the blue illumination beams 80a and 80b respectively provided by the first light source 611 and the second light source 613 of the light source module 610 through the control unit 160, and adjust a ratio of the color temperature of the first sub illumination beam 70a and the color temperature of the second sub illumination beam 70b according to an actual requirement, so as to obtain the required color temperature of the illumination beam 70 projected out of the vehicle lighting device 600. For example, as shown in FIG. 6C, when the light intensity of the blue illumination beam 80a emitted from the first light source 611 is higher than the light intensity of the blue illumination beam 80b emitted from the second light source 613, the illumination beam 70 with a lower color temperature is obtained through mixing, and as shown in FIG. 6D, when the light intensity of the blue illumination beam 80a emitted by the first light source 611 is lower than the light intensity of the blue illumination beam 80b emitted by the second light source 613, the illumination beam 70 with a higher color temperature is obtained through mixing. In this way, the vehicle lighting device 600 can also adjust the color temperature of the illumination beam 70 according to a weather condition, an environmental condition or user's preference, such that the vehicle lighting device 600 is adapted to the driving condition of that moment.

Moreover, in the embodiment, the sensing unit 540 of the vehicle lighting device 600 can also simultaneously adopts the aforementioned CMOS sensor and the TOF sensor to accurately obtain the relative distance between the vehicle CA coming from the opposite direction and the vehicle lighting device 600, and the control unit 160 can dynamically adjust the light distribution pattern of the illumination beam 70. In this way, while an adequate lighting effect is maintained, the driver in the vehicle CA coming from the opposite direction is avoided to feel a glare.

Therefore, the vehicle lighting device 600 and the method for controlling the vehicle lighting device can use the light valve 130 to adjust and control the illumination beam 70 to implement the function of stepless adjustment of the light distribution pattern, and the sensing unit 540 can be used to sense the environmental requirement, so as to adjust the light distribution pattern, the brightness and the illumination range of the illumination beam 70 to satisfy various driving conditions and cope with related specification standards. Therefore, the vehicle lighting device 600 also have the advantages mentioned in description of the vehicle lighting device 500, which are not repeated.

In summary, the vehicle lighting device and the method for controlling the vehicle lighting device can adjust and control the illumination beam through the light valve, so as to implement the function of stepless adjustment of the light distribution pattern. Moreover, the vehicle lighting device and the method for controlling the vehicle lighting device can use the sensing unit to sense the environmental requirement in the front of the vehicle lighting device, and can adjust the illumination region of the illumination beam according to the signal of the sensing unit, so as to obtain the light distribution pattern, the brightness and the illumination range required by the high beam, the low beam and the adaptive front lighting system. In addition, the vehicle lighting device and the method for controlling the vehicle lighting device can also adjust the color temperature of the illumination beam according to a relative speed of the vehicle coming from the opposite direction, a road environment and a weather condition, so as to satisfy various driving conditions and cope with related specification standards.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents. Moreover, any embodiment of or the claims of the invention is unnecessary to implement all advantages or features disclosed by the invention. Moreover, the abstract and the name of the invention are only used to assist patent searching. Moreover, “first”, “second”, etc. mentioned in the specification and the claims are merely used to name the elements and should not be regarded as limiting the upper or lower bound of the number of the components/devices.

What is claimed is:

1. A vehicle lighting device, comprising:
a light source module, providing an illumination beam;
a light valve, located on a transmission path of the illumination beam, and capable of being switched to different states for adjusting and controlling the illumination beam;
a sensing unit, configured to sense the front of the vehicle lighting device, and generating a signal, correspondingly;
a projection lens set, disposed on an optical path of the illumination beam, and configured to project at least a portion of the illumination beam, wherein the light valve is located between the light source module and the projection lens set; and
a control unit, electrically connected to the light valve and the sensing unit, and configured to receive the signal output from the sensing unit, wherein the control unit controls the light valve to adjust a light distribution pattern of the illumination beam according to the signal, and to project the illumination beam to the front through the projection lens set.

2. The vehicle lighting device as claimed in claim 1, wherein the projection lens set comprises a zoom lens, the zoom lens is electrically connected to the control unit, and is configured to control a projection distance of the illumination beam projected out of the projection lens set.

3. The vehicle lighting device as claimed in claim 1, wherein the light valve comprises a digital micro-mirror device, the digital micro-mirror device comprises a plurality of micro-mirrors, and the control unit controls states of the micro-mirrors to reflect the portion of the illumination beam and adjust the light distribution pattern of the illumination beam.

4. The vehicle lighting device as claimed in claim 1, wherein the light source module comprises at least one first light source and at least one second light source for respectively providing a first sub illumination beam and a second sub illumination beam of the illumination beam, and a color temperature of the first sub illumination beam and a color temperature of the second sub illumination beam are different.

5. The vehicle lighting device as claimed in claim 4, wherein the control unit controls light intensities of the first sub illumination beam and the second sub illumination beam of the light source module, so as to adjust a color temperature of the illumination beam.

6. The vehicle lighting device as claimed in claim 4, wherein the light source module further comprises:
at least one first light wavelength converting unit, located between the at least one first light source and the light valve; and
at least one second light wavelength converting unit, located between the at least one second light source and the light valve, wherein the first light wavelength converting unit and the second light wavelength converting unit respectively correspond to the at least one first light source and the at least one second light source, and the first sub illumination beam and the second sub illumination beam are respectively converted by the first light wavelength converting unit and the second light wavelength converting unit.

7. The vehicle lighting device as claimed in claim 4, wherein the at least one first light source and the at least one second light source are solid-state light sources.

8. The vehicle lighting device as claimed in claim 3, wherein the micro-mirrors are capable of oscillating independently, and different states of the micro-mirrors correspond to different oscillating angles and control a reflecting direction that the illumination beam irradiates each of the micro-mirrors, so as to adjust the light shape of at least a portion of the illumination beam.

9. The vehicle lighting device as claimed in claim 1, further comprising a relay lens set located on the transmission path of the illumination beam, and located between the light source module and the light valve, wherein the illumination beam is transmitted to the light valve through the relay lens set.

10. The vehicle lighting device as claimed in claim 1, wherein the sensing unit is a complementary metal-oxide-semiconductor (CMOS) sensor, a time-of-flight (TOF) sensor or a humidity sensor.

11. The vehicle lighting device as claimed in claim 1, wherein the signal comprises image information, position information related to a vehicle coming from the opposite direction or humidity information.

12. The vehicle lighting device as claimed in claim 11, wherein the control unit determines whether the vehicle coming from the opposite direction exists and a relative distance between the vehicle coming from the opposite direction and the sensing unit according to the signal having the image information or the position information related to the vehicle coming from the opposite direction, and the control unit controls the light valve to adjust the light distribution pattern of the illumination beam when determining that the vehicle coming from the opposite direction exists in the front.

13. The vehicle lighting device as claimed in claim 11, wherein the control unit is electronically connected to the light source module, and when the humidity information reaches a predetermined value, the control unit controls the light source module to adjust the color temperature of the illumination beam.

14. A method for controlling a vehicle lighting device, capable of controlling a light distribution pattern of an illumination beam, and the method for controlling the vehicle lighting device comprising:
causing a sensing unit to sense the front of the vehicle lighting device and to generate a signal; and
controlling a light valve located on a transmission path of the illumination beam according to the signal, so as to adjust the light distribution pattern of at least a portion of the illumination beam.

15. The method for controlling the vehicle lighting device as claimed in claim 14, wherein the illumination beam is provided by a light source module, and the light valve comprises a digital micro-mirror device, the digital micro-mirror device comprises a plurality of micro-mirrors, each of the micro-mirrors is capable of oscillating independently and is capable of being switched to different states, the different states of the micro-mirrors correspond to different oscillating angles, the states of the micro-mirrors are controlled to control a reflecting direction that the illumination beam irradiates each of the micro-mirrors, such that the digital micro-mirror device adjusts the light distribution pattern of at least a portion of the illumination beam through the micro-mirrors.

16. The method for controlling the vehicle lighting device as claimed in claim 14, wherein the vehicle lighting device further includes a projection lens set configured to project the at least a portion of the illumination beam, and the light valve is located between the light source module and the projection lens set.

17. The method for controlling the vehicle lighting device as claimed in claim 16, wherein the projection lens set comprises a zoom lens, the zoom lens is electrically connected to the control unit, and is configured to control a projection distance of the at least a portion of the illumination beam projected out of the projection lens set.

18. The method for controlling the vehicle lighting device as claimed in claim 15, wherein the illumination beam comprises a first sub illumination beam and a second sub illumination beam, a color temperature of the first sub illumination beam and a color temperature of the second sub illumination beam are different, and the method for controlling the vehicle lighting device further comprises:
controlling light intensities of the first sub illumination beam and the second sub illumination beam, so as to adjust a color temperature of the illumination beam.

19. The method for controlling the vehicle lighting device as claimed in claim 18, wherein the light source module further comprises:
at least one first light source and at least one second light source, respectively configured to provide the first sub illumination beam and the second sub illumination beam;
at least one first light wavelength converting unit, located between the at least one first light source and the digital micro-mirror device; and
at least one second light wavelength converting unit, located between the at least one second light source and the digital micro-mirror device, and the at least one first light wavelength converting unit and the at least one second light wavelength converting unit respectively correspond to the at least one first light source and the at least one second light source, and the first sub illumination beam and the second sub illumination beam are respectively converted by the at least one first light wavelength converting unit and the at least one second light wavelength converting unit.

20. The method for controlling the vehicle lighting device as claimed in claim 14, wherein the sensing unit is a complementary metal-oxide-semiconductor (CMOS) sensor, a time-of-flight (TOF) sensor or a humidity sensor.

21. The method for controlling the vehicle lighting device as claimed in claim 14, wherein the signal comprises image information, position information related to a vehicle coming from the opposite direction or humidity information.

22. The method for controlling the vehicle lighting device as claimed in claim 21, further comprising:
controlling the light source module to adjust the color temperature of the illumination beam when the humidity information reaches a predetermined value.

23. The method for controlling the vehicle lighting device as claimed in claim 21, further comprising:
determining whether a vehicle coming from the opposite direction exists and a relative distance between the vehicle coming from the opposite direction and the sensing unit according to the signal having the image information or the position information related to the vehicle coming from the opposite direction, and controlling the light valve to adjust the light distribution pattern of the illumination beam when determining that the vehicle coming from the opposite direction exists in the front.
